(19) United States
(12) Patent Application Publication
(10) Pub. No.: US 2005/0259219 A1
(43) Pub. Date: Nov. 24, 2005

(54) Glasses and/or goggles for sportswear and protective use

(76) Inventor: Andreas Helbrecht, Hilden (DE)

Correspondence Address: BECKER & POLIAKOFF, P.A., 3111 STIRLING ROAD, FT. LAUDERDALE, FL, 33312, US

(21) Appl. No.: 10/963,233

(22) Filed: Oct. 12, 2004

(30) Foreign Application Priority Data
May 19, 2004 (DE) 20 2004 008 164.4

(51) Int. Cl. G02C 1/00; G02C 5/14

(52) U.S. Cl. 351/116

(57) ABSTRACT

The present invention provides a pair of glasses or goggles which can be used as sportswear, in particular as motorcycle goggles, and also as glasses for leisure use and are easy to handle in different situations.

Pursuant to 35 U.S.C. § 119 (e), this application claims priority to German Patent Application No. 20 2004 008 164.4 filed May 19, 2004.

The invention relates to a pair of glasses and/or goggles having side pieces, in particular a pair of motorcycle goggles.

Various motorcycle goggles having side pieces or a strap for fixing them on the head are known.

The object of the invention is to provide a pair of glasses or goggles which can be used as sportswear, in particular as motorcycle goggles, and also as glasses for leisure use and are easy to handle in different situations.

This object is achieved by the subject matter of the independent claim. Advantageous embodiments are claimed in the subclaims.

The invention is based on the connection between the glasses and/or goggles frames and the side pieces or straps being configured by a latching element, with the result that this connection can be closed and opened again quickly and easily and without being destroyed.

A particular advantage here is that different types of side piece adapted to the respective use conditions can easily be connected to the frame.

It is particularly advantageous for the use of the invention as motorcycle goggles that use can be made of flexible straps with the free ends connected to one another via a touch-and-close fastener. This allows the goggles to sit securely on the head and/or on or beneath the helmet.

The particularly advantageous combination of the connection according to the invention between the side piece and frame and the closure of the straps using a touch-and-close fastener allows the goggles to be held securely on the head, beneath the motorcyclist's helmet; at the same time, the goggles can be removed quickly—even in the event of an emergency—by way of the latching closures according to the invention, it being possible for the side pieces to remain beneath the helmet. This combines the advantages of a pair of goggles, which are secured on the wearer's head via a continuous elastic strap, with the ease of putting on and taking off a pair of glasses with conventional side pieces when a helmet is being worn.

Furthermore, it is also readily possible to replace parts of straps, e.g. when part of the touch-and-close fastener is soiled.

For leisure use, it is possible for the flexible side pieces, for reasons of comfort and appearance, to be quickly and easily exchanged for conventional side pieces.

In a further advantageous configuration, the lenses can be exchanged without being destroyed and without the aid of auxiliary means. The flexibility of the lenses and/or of a mount and/or of the frame is utilized particularly advantageously for this purpose.

The quick exchange of the lenses can be used in order for the advantageous tinting of the lenses to be adapted, by way of different levels of tinting, to the conditions in hand.

For safety reasons, the lenses advantageously consist of a splinter-proof plastic.

The invention is explained in more detail below with reference to an exemplary embodiment illustrated in the drawing, in which:

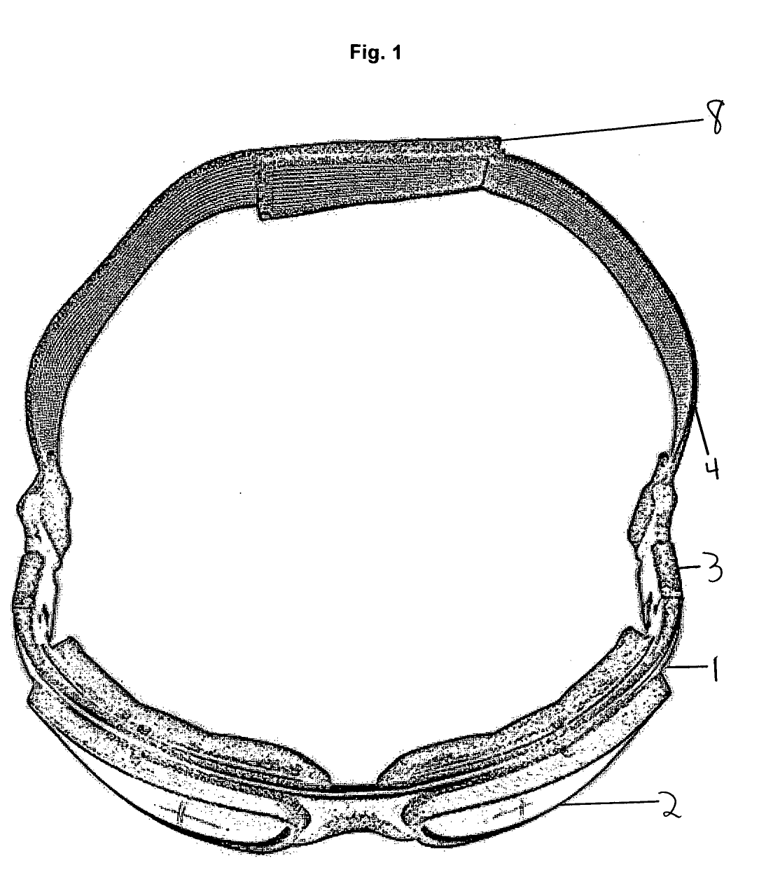

FIG. 1 shows a plan view of a configuration of a pair of glasses and/or goggles according to the invention with a pair of flexible side pieces;

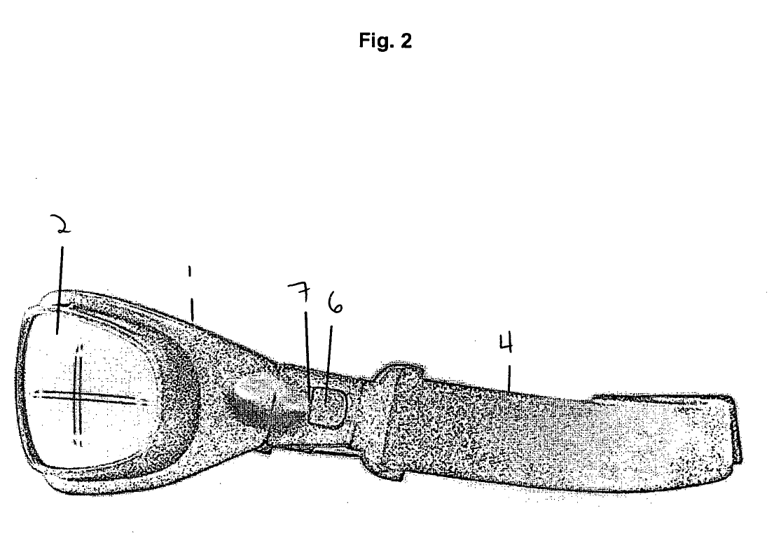

FIG. 2 shows a side view of the glasses and/or goggles from FIG. 1; and

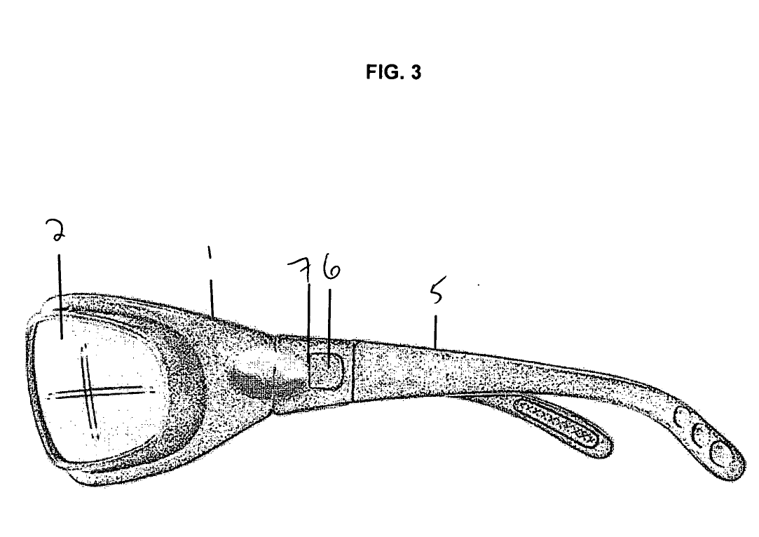

FIG. 3 shows the glasses and/or goggles according to the invention with a pair of conventional side pieces.

The glasses and/or goggles according to the invention comprise a frame 1 with two cutouts into which corresponding lenses 2 are inserted.

On the inside (the face side) of the frame, continuous padded framing elements 3 are arranged around the cutouts. These framing elements serve to avoid pressure marks on the wearer's skin caused by the hard frame 1 resting thereon.

Furthermore, they seal the gap between the frame 1 and the face, with the result that the wearer's eyes are protected against possible relative wind.

The connection between the frame 1 and the side pieces 5 or straps 4 of the glasses and/or goggles is produced via a latch-in closure. The frame is provided with a push-in means in the form of a gap, into which a corresponding part of the side piece 5 or strap 4 is pushed. During the pushing-in operation, an elastic locking element 6 is deflected in order, in the fixing position between the frame 1 and side piece 5 or strap 4, to return into its starting position again and, in the process, to latch into a recess 7 of the frame 1.

In order to release the side piece 5 or strap 4, the locking element 6 is deflected manually, with the result that the side piece 5 or the strap 4 can be drawn out of the push-in means of the frame 1.

In this way, any desired form of side piece 5 or strap 4 can be connected, as required, to the frame 1.

A first embodiment comprises two elastic straps 4, which are connected to one another by a touch-and-close fastener 8 in the region of the back of the wearer's head. These are suitable, in particular, when pronounced vibration, for example during motorcycling or some other sporting activity, could otherwise result in the glasses and/or goggles slipping down.

The second form of side piece 5 is distinguished by appearance and wearing comfort.

1. A pair of glasses and/or goggles having:
a. at least one lens (2),
b. a frame (1),
c. and two side pieces (5) or straps (4), which can be connected to the frame (1) and released from the frame (1) again, without being destroyed,
wherein the side pieces (5) or straps (4) have, at one end, a latching element (6) which, for fastening to the frame (1), latches into a recess (7) of the frame (1), and can be manually released again.

2. The glasses and/or goggles as claimed in claim 1, wherein the side pieces (5) or straps (4) have a fastening element of a touch-and-close fastener (8) at the respectively free end.

3. The glasses and/or goggles as claimed in claim 1 or 2, wherein the at least one lense (2) can easily be exchanged without being destroyed.

4. The glasses and/or goggles as claimed in one of the preceding claims, wherein the at least one lense (2) is tinted.

5. The glasses and/or goggles as claimed in one of the preceding claims, wherein the at least one lense (2) consists of a splinter-proof plastic
